(19) United States
(12) Patent Application Publication
(10) Pub. No.: US 2007/0117710 A1
(43) Pub. Date: May 24, 2007

(54) Method for reducing ammonia and other gases from the detonation of explosives

(76) Inventors: John Carlyle Lawrence, Thompson Falls, MT (US); Gary D. Babbitt, Boise, ID (US); John Steve Wasson, Red Deer (CA)

Correspondence Address: John C. Lawrence, P.O. Box 643, Thompson Falls, MT, 59873, US

(21) Appl. No.: 11/284,680

(22) Filed: Nov. 21, 2005

(51) Int. Cl. B01J 29/04

(52) U.S. Cl. 502/60

(57) ABSTRACT

A method for reducing ammonia and other gases from the detonation of explosives. A method in accordance with the invention comprises placing an ion exchange agent such as a natural occurring zeolite mineral like clinoptilolite around the blast area, over the top of the blast area, under the area receiving the blasted material, within the blast holes or chambers holding the explosives, in the water covering the blast area, over the top of the blasted material, mixed in the explosives and the like. The ammonia and various other gases exchange into the lattice of the ion exchange agent where they become insoluble. This creates a healthier work environment for workers and reduces environmental pollution.

### BACKGROUND

The use of blasting agents and various explosives create ammonia gas and various other gases and derivatives that present (1) human, animal and plant health problems as well as (2) environmental problems. These problems can be mitigated by the use of an ion exchange material. Natural occurring zeolites such as clinoptilolite are relatively inexpensive, and they exchange ammonium into their lattice where it is not water-soluble. The use of ammonium nitrate fuel only (ANFO) explosives has become widespread due to its relative low cost compared to other explosives. Incomplete detonation and spillage have resulted in the release of ammonia and other gases. In underground operations, ammonia gas levels often exceed 150 ppm ammonia which create human health problems that can be lethal as well as counterproductive. Nausea, dizziness and other symptoms make work difficult. The use of zeolite makes the work environment safe and more productive.

The release of ammonia gas to the environment enhances the release of ammonium, which oxidizes to nitrites and nitrates. These derivatives pollute the groundwater and become major environmental problems. The ammonium is exchanged into the ion exchange material so that they are not water-soluble. When the ion exchange material becomes loaded with ammonium cations, it may be used as a fertilizer where the nitrogen is plant accessible but not water-soluble. The ammonium (nitrogen) is released as the plant releases hydrogen ions.

### PREFERRED EMBODIMENT

Prior to the use of explosives for blast holes, plasters, in large cavities in underground or surface activities and the like, an ion exchange agent is spread over the blast area, onto a receiving area for the blasted material, mixed in with the blasting agent, placed in an area around the periphery of the blast area, or on top of concrete floors receiving the blasted material that will remove ammonia and other gases by ion exchange. The ion exchange material can also be spread over the top of the blasted material following detonation.

We claim:

1. An ion exchange material comprising zeolite having the means to adsorb ammonia from the air wherein ammonia is released into the air after detonation of an explosive.

2. The ion exchange material in claim 1 comprising clinoptilolite, mordenite, analcime, chabazite, stilbite, natrolite, heulandite, phillipsite, natrolite, laumontite, and stilbite.

3. The ion exchange material in claim 2 comprising a synthetic zeolite.

4. The ion exchange material in claim 1 having the means to adsorb nitrous oxides, nitrogen and the like.

5. The process in claim 1 wherein the zeolite comprises a predetermined size of not more than 15.0 millimeters.

6. The process in claim 1 wherein a predetermined amount of zeolite is disposed around the explosive in drill holes and the like.

7. The process in claim 1 wherein a predetermined amount of zeolite covers a predetermined surface area surrounding the explosive detonation.

8. The process in claim 1 wherein a predetermined amount of zeolite is mixed with the explosive.

9. The ion exchange material is disposed in predetermined amounts in underground operations, tunnels and the like wherein ammonia is removed from the working environment by adsorption.

10. The process in claim 1 comprising zeolite having the means to adsorb ammonia from water wherein ammonia, ammonia compounds and the like are released into the water after detonation of an explosive.

11. The process in claim 10 wherein a predetermined amount of zeolite covers a predetermined surface area surrounding the explosive detonation under water.

12. The process in claim 10 wherein a predetermined amount of zeolite is mixed with the explosive under water.

13. The process in claim 10 wherein a predetermined amount of zeolite is disposed around the explosive in drill holes and the like under water.

14. The process in claim 1 comprises explosives selected from the group consisting of ammonium nitrate, nitro carbo nitrate, nitroglycerin (NG), ammonia dynamite, straight dynamite, low-density ammonia dynamite, blasting gelatin, straight gelatin, ammonia gelatin, semigelatin, permissible explosives, dry blasting agents, liquid oxygen explosive (LOX), black powder, slurries (water gels), emulsions, ammonium nitrate fuel oil (ANFO), aluminized slurries, trinitrotolunene (TNT) and the like.
